(19) United States
(12) Patent Application Publication
(10) Pub. No.: US 2016/0197672 A1
(43) Pub. Date: Jul. 7, 2016

(54) METHOD OF MEASURING OPTICAL RETURN LOSS

(71) Applicant: AFL TELECOMMUNICATIONS LLC, Duncan, SC (US)

(72) Inventor: Michael SCHOLTEN, Westford, MA (US)

(73) Assignee: AFL Telecommunications LLC, Duncan, SC (US)

(21) Appl. No.: 14/443,806

(22) PCT Filed: Jul. 22, 2014
(86) PCT No.: PCT/US14/47648

§ 371 Date: May 19, 2015

Related U.S. Application Data
(60) Provisional application No. 61/856,872, filed on Jul. 22, 2013.

(51) Int. Cl. H04B 10/079; H04B 10/071

(52) U.S. Cl. CPC H04B 10/07955; H04B 10/071

(57) ABSTRACT

A method of calculating optical return loss (ORL) in a fiber network includes injecting a plurality of pulses of light at a known first power level into the fiber network, determining a location at which end reflection is detected, measuring a second power level of each of a plurality of returned pulses of light, measuring a third power level of a pulse of light returned from the determined location, and calculating ORL based on the first power level, the second power level and the third power level.

### CROSS-REFERENCE TO RELATED APPLICATIONS

This application is based upon and claims the benefit of priority from U.S. Provisional Application No. 61/856,872, filed Jul. 22, 2013 in the United States Patent and Trademark Office, the disclosures of which are incorporated herein in its entirety by reference.

### BACKGROUND

1. Field

The invention is related to a method of measuring optical return loss in a fiber network, and more particularly to simplifying the process of measuring optical return loss in a fiber network.

2. Related Art

The background information provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Measuring insertion loss and length using an Optical Loss Test Set (OLTS) requires a test set at each end of the fiber. Measuring Optical Return Loss (ORL) using a combined OLTS/ORL meter requires ensuring that the far-end connector is properly terminated. Consequently, to make loss and ORL measurements using an OLTS/ORL requires technicians at both ends of the fiber-under-test (FUT).

One significant advantage of an optical time-domain reflectometer (OTDR) over an OLTS/ORL meter is that it can provide end-to-end length, insertion loss and ORL measurements from one end of the fiber-under-test. However, to obtain a useful ORL measurement using an OTDR, one of the following conditions must be met:

1. The far-end of the fiber network is already connected to the normal network equipment (not usually the case during installation, but may be the case during troubleshooting);

2. The far-end connection is terminated with an APC connector (seldom the case, except in Fiber to the x (FTTx) and video networks);

3. The far-end connection is terminated with a receive cable or termination connector (requires a technician at the far end of the fiber network).

For cases in which the far-end of the fiber-under-test is an open PC connector, a technician is required at the far end of the network to terminate the open connection. The need for this technician could be eliminated if the OTDR includes an option to exclude the end reflection from the computed ORL, thereby simplifying test setup and reducing test time and cost.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

According to an aspect of an exemplary embodiment, a method of calculating optical return loss (ORL) in a fiber network includes injecting a plurality of pulses of light at a known first power level into the fiber network, determining a location at which end reflection is detected, measuring a second power level of each of a plurality of returned pulses of light, measuring a third power level of a pulse of light returned from the determined location, and calculating ORL based on the first power level, the second power level and the third power level.

According to another exemplary embodiment, the calculating further includes excluding the third power level from the calculation.

According to another exemplary embodiment, the calculating further includes calculating the ORL using the formula ORL=10×log Σ(P_{inject i}/P_{return i}), where P denoted power level and i denotes samples taken over a period of time until the injected plurality of pulses have exited fiber and all reflections have been received.

According to another exemplary embodiment, the calculating further includes excluding the third power level from the calculation.

According to another exemplary embodiment, the first power level, the second power level and the third power level are measured in watts.

According to another exemplary embodiment, the measuring the second power level further includes measuring the second power level of each of the plurality of returned pulses of light per unit time.

According to an aspect of an exemplary embodiment, a non-transitory computer readable recording medium storing a program used in an apparatus, including at least one processor, for calculating optical return loss (ORL) in a fiber network, causes said at least one processor to inject a plurality of pulses of light at a known first power level into the fiber network, determine a location at which end reflection is detected, measure a second power level of each of a plurality of returned pulses of light, measure a third power level of a pulse of light returned from the determined location, and calculate ORL based on the first power level, the second power level and the third power level.

According to another exemplary embodiment, the program further causes said at least one processor to exclude the third power level from the calculation.

According to another exemplary embodiment, the program further causes said at least one processor to calculate the ORL using the formula ORL=10×log Σ(P_{inject i}/P_{return i}), where P denoted power level and i denotes samples taken over a period of time until the injected plurality of pulses have exited fiber and all reflections have been received.

According to another exemplary embodiment, the program further causes said at least one processor to exclude the third power level from the calculation.

According to another exemplary embodiment, the first power level, the second power level and the third power level are measured in watts.

According to another exemplary embodiment, the program further causes said at least one processor to measure the second power level of each of the plurality of returned pulses of light per unit time.

### BRIEF DESCRIPTION OF THE DRAWING

FIG. 1 illustrates an OTDR measured ORL with a large reflection at an open ultra-polished connector (UPC) end of a fiber-under-test, according to an exemplary embodiment.

FIG. 2 illustrates an OTDR measured ORL for a fiber comprising a properly terminated end, according to an exemplary embodiment.

FIG. 3 illustrates an OTDR measured ORL emphasizing on the open end reflection dominating the ORL, according to an exemplary embodiment.

FIG. 4 illustrates an OTDR measured ORL emphasizing the excessive reflection to be excluded from the ORL measurement, according to an exemplary embodiment.

FIG. 5 illustrates an OTDR measured ORL detailing the exclusion of the reflection contribution of a far-end connector, according to an exemplary embodiment.

FIG. 6 is a flowchart describing the steps for computing ORL while excluding the reflection contribution of a far-end connector, according to an exemplary embodiment.

FIG. 7 illustrates a functional block diagram of an embodiment of an apparatus comprising a processor which calculates optical return loss (ORL) in a fiber network, according to an exemplary embodiment.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

An OTDR computes ORL by measuring and summing fiber backscatter and discrete reflections relative to the launch power of the optical pulses it transmits down the fiber. For cases in which the far-end of the fiber-under-test is an open connector, resulting in a strong reflection, the measured ORL level could be considered unacceptable due to the contribution from the open end of the fiber-under-test.

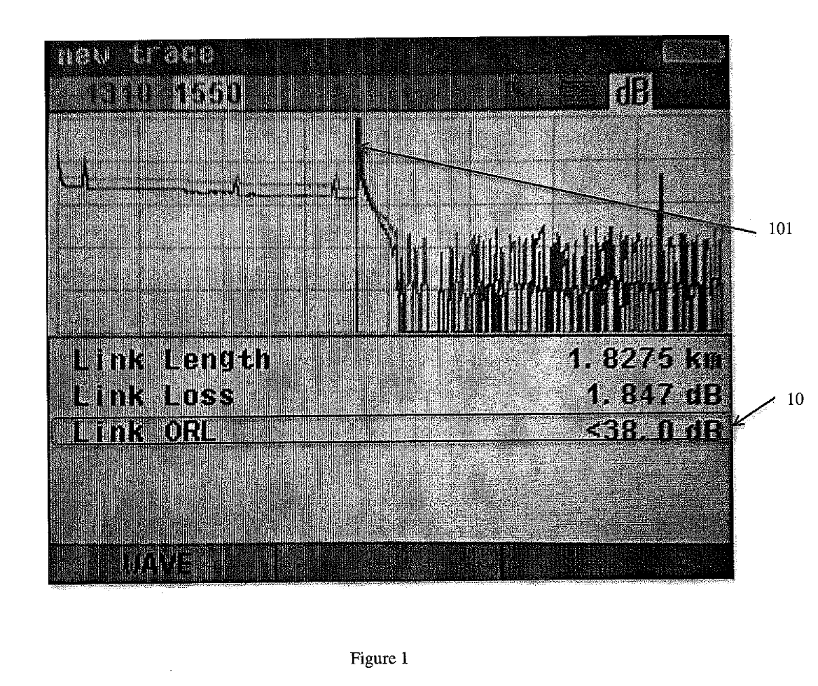

Referring to the drawings, FIG. 1 illustrates an OTDR measured ORL with a large reflection at an open ultra-polished connector (UPC) end of a fiber-under-test, according to an exemplary embodiment.

Because of a presence of an open UPC end of the fiber-under-test, a large reflection 101 becomes a dominant contributor leading to an unacceptable ORL calculation. In such a situation, the ORL is displayed in a format of “<nn.nn” 102 as the FUT includes a saturated and/or clipped reflection.

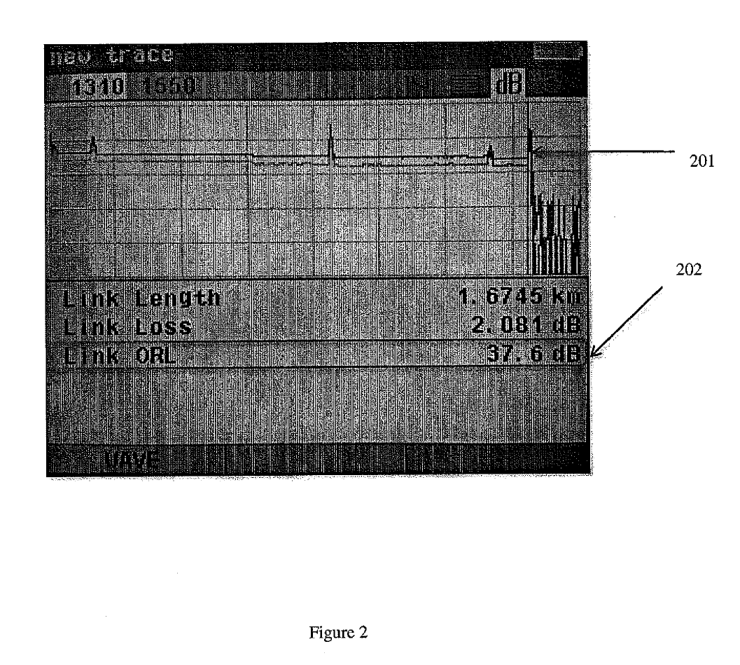

FIG. 2, on the other hand, illustrates an OTDR measured ORL for a fiber comprising a properly terminated end, according to an exemplary embodiment.

As the FUT is properly terminated in this scenario, the FUT does not incorporate a saturated and/or clipped reflection 201 thereby providing an acceptable ORL calculation 202.

However, a technician is required at the far end of the network to terminate the open connection to achieve readings as shown in FIG. 2. A modified algorithm which allows ORL to be computed while excluding the far-end reflection would provide a user with a representative value of the network's ORL assuming the fiber-under-test was terminated normally.

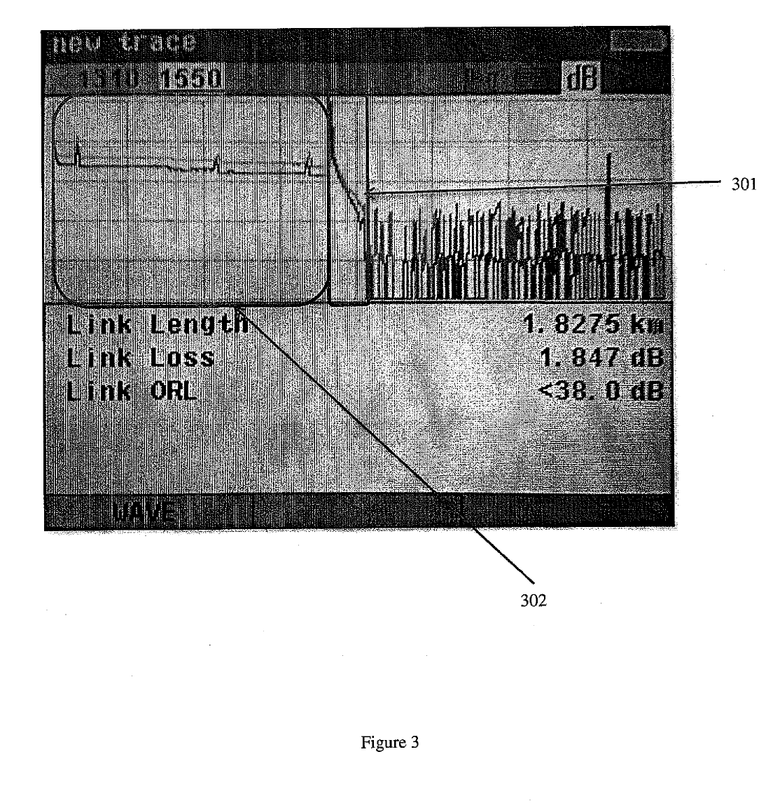

FIG. 3 illustrates an OTDR measured ORL emphasizing on the open end reflection dominating the ORL, according to an exemplary embodiment.

The open end reflection 301 dominates the ORL leading to an unacceptable measurement of ORL which is not indicative of the actual network ORL 302.

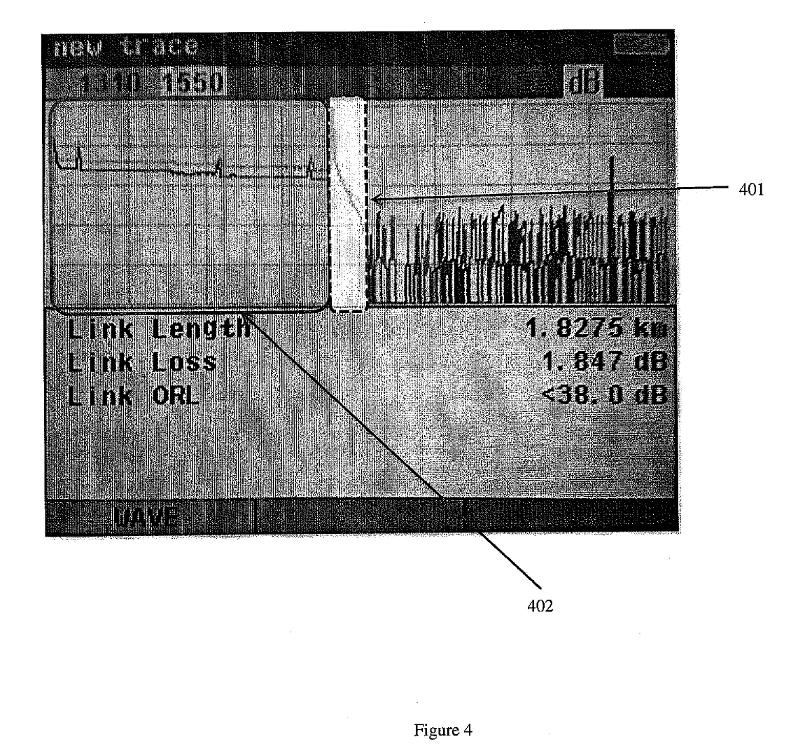

FIG. 4 illustrates an OTDR measured ORL emphasizing the excessive reflection to be excluded from the ORL measurement, according to an exemplary embodiment.

The emphasized area 401 depicts the excessive reflection due to an open connector. Exclusion of the emphasized area 401 would yield a result 402 representative of a network with a properly terminated end.

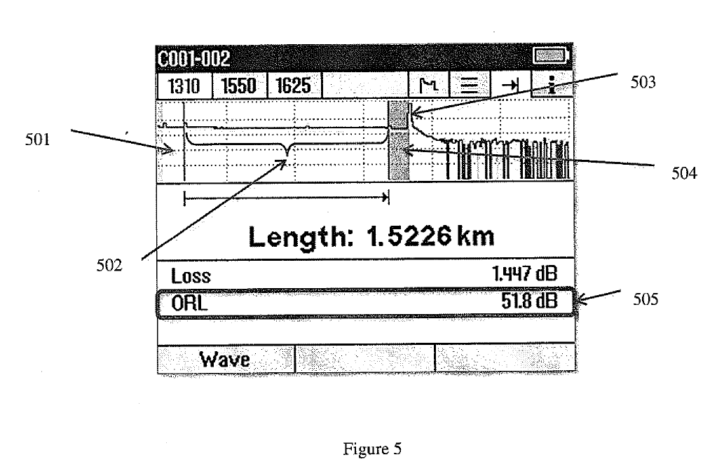

FIG. 5 illustrates an OTDR measured ORL detailing the exclusion of the reflection contribution of a far-end connector, according to an exemplary embodiment.

Region 501 depicts the launch fiber readings. Region 502 depicts ORL region including the first and last connection to FUT. 503 depicts the large reflection at the open end of the receive cable, which is excluded from the ORL calculation. Region 504 depicts readings of the receive fiber. The measured and displayed ORL 505 incorporates end-to-end ORL excluding the reflection and backscatter from launch and receive cables, as well as excess reflection from open end at far-end of receive cable, according to an exemplary embodiment.

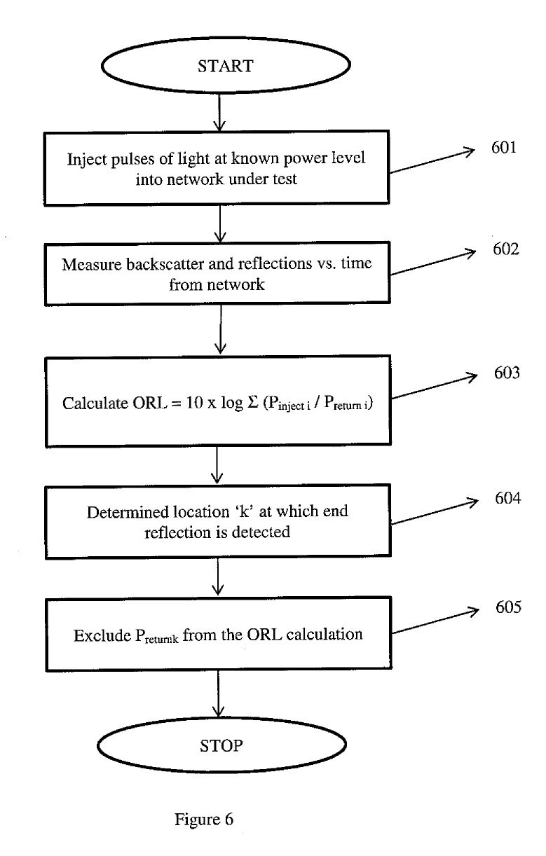

FIG. 6 is a flowchart describing the steps for computing ORL while excluding the reflection contribution of a far-end connector, according to an exemplary embodiment.

Optical Continuous Wave Reflectometer (OCWR) measured ORL is obtained by injecting known continuous wave (CW) light at a known power level into network under test. The average return power level from network under test is measured. The ORL is calculated using the following formula:

ORL=10×log (P_{inject} /Pᵣₑₜᵤᵣₙ)(power measured in Watts)

Since CW light injected and measured cannot separate contribution of individual reflections, such as open end connection, the reflection contribution of a far-end connector cannot be excluded in an OCWR measured ORL.

OTDR-computed ORL is obtained by injecting pulses of light at known power level into network under test. Measurements of backscatter and reflections vs. time from the network are taken. The ORL is computed using the following formula:

ORL=10×log E (P_{inject i}/P_{return i}), where i samples are taken from time 0 until injected pulse has exited fiber and all reflections have been received

Accordingly, a location “k” at which end reflection is detected can be determined. P_{return k} can then be excluded from the ORL calculation eliminating the effect of the excessive reflection from the open end.

Going back to FIG. 6, at step 601, pulses of light at known power level are injected into network under test. At step 602, the backscatter and reflections vs. time from network are measured. At step 603, the ORL is computed using the formula ORL=10×log Σ(P_{inject i}/P_{return i}). At step 604, a location ‘k’, at which end reflection is detected, is determined. At step 605, value P_{return k} is excluded from the calculation of ORL yielding a resultant ORL computed value representative of a network with a properly terminated end.

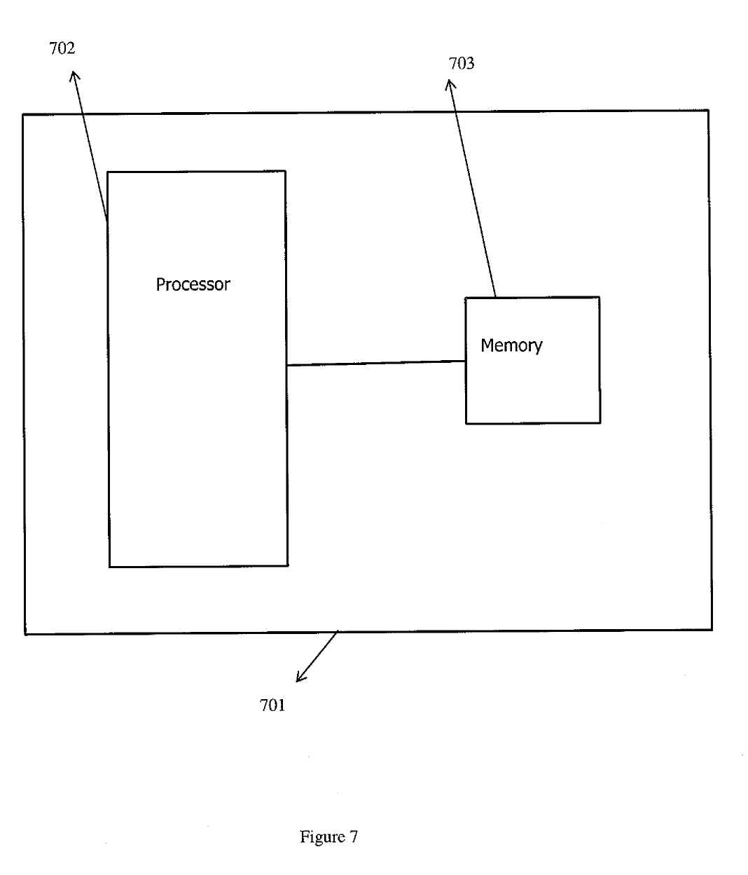

FIG. 7 illustrates a functional block diagram of an embodiment of an apparatus comprising a processor which calculates optical return loss (ORL) in a fiber network, according to an exemplary embodiment.

A non-transitory computer readable recording medium storing a program may be used in an apparatus 701. The apparatus includes a memory 703 and an processor 702, according to an exemplary embodiment. An example of a processor is an ARM Xscale 806 Mhz processor. An example of a memory is an 8 Gbit NAND flash memory. The memory may store a program code/operating software which in-turn instructs the processor 602 to calculate optical return loss (ORL) in a fiber network as described in a flow chard of FIG. 6. The program code/operating software may also be stored on a non-transitory computer readable medium.

A key benefit of the ability to compute ORL while excluding the reflection contribution of a far-end connector is that ORL can be measured from a single end without the need to terminate the open connection with a receive cable or an optical termination. This allows a single user to measure end-to-end loss and ORL of the network without requiring an assistant at the far end of the network, reducing test time and cost.

Although some benefits of modifying an algorithm to compute ORL while excluding the reflection contribution of a far-end connector are listed above, the benefits are not limited thereto.

As mentioned above, the embodiments described above are merely exemplary and the general inventive concept should not be limited thereto. While this specification contains many features, the features should not be construed as limitations on the scope of the disclosure or the appended claims. Certain features described in the context of separate embodiments can also be implemented in combination. Conversely, various features described in the context of a single embodiment can also be implemented in multiple embodiments separately or in any suitable sub-combination.

1. A method of calculating optical return loss (ORL) in a fiber network, the method comprising:
injecting a plurality of pulses of light at a known first power level into the fiber network;
determining a location at which end reflection is detected;
measuring a second power level of each of a plurality of returned pulses of light;
measuring a third power level of a pulse of light returned from the determined location; and
calculating ORL based on the first power level, the second power level and the third power level.

2. The method according to claim 1, wherein
the calculating further comprises excluding the third power level from the calculation.

3. The method according to claim 1, wherein
the calculating further comprises calculating the ORL using the formula:
ORL=10×log Σ(P_{inject i}/P_{return i}), where P denoted power level and i denotes samples taken over a period of time until the injected plurality of pulses have exited fiber and all reflections have been received.

4. The method according to claim 3, wherein
the calculating further comprises excluding the third power level from the calculation.

5. The method according to claim 1, wherein
the first power level, the second power level and the third power level are measured in watts.

6. The method according to claim 1, wherein
the measuring the second power level further comprises measuring the second power level of each of the plurality of returned pulses of light per unit time.

7. A non-transitory computer readable recording medium storing a program used in an apparatus, including at least one processor, for calculating optical return loss (ORL) in a fiber network, the program causing said at least one processor to:
inject a plurality of pulses of light at a known first power level into the fiber network;
determine a location at which end reflection is detected;
measure a second power level of each of a plurality of returned pulses of light;
measure a third power level of a pulse of light returned from the determined location; and
calculate ORL based on the first power level, the second power level and the third power level.

8. The non-transitory computer readable recording medium of claim 7, the program further causes said at least one processor to:
exclude the third power level from the calculation.

9. The non-transitory computer readable recording medium of claim 7, the program further causes said at least one processor to:
calculate the ORL using the formula:
ORL=10×log Σ(P_{inject i}/P_{return i}), where P denoted power level and i denotes samples taken over a period of time until the injected plurality of pulses have exited fiber and all reflections have been received.

10. The non-transitory computer readable recording medium of claim 9, the program further causes said at least one processor to:
exclude the third power level from the calculation.

11. The non-transitory computer readable recording medium of claim 7, wherein
the first power level, the second power level and the third power level are measured in watts.

12. The non-transitory computer readable recording medium of claim 7, the program further causes said at least one processor to:
measure the second power level of each of the plurality of returned pulses of light per unit time.
